(19) United States
(12) Patent Application Publication
(10) Pub. No.: US 2019/0143255 A1
(43) Pub. Date: May 16, 2019

(54) CO2 Capture via Deformable Cold Surfaces

(71) Applicant: Robert D. Kaminsky, Houston, TX (US)

(72) Inventor: Robert D. Kaminsky, Houston, TX (US)

(21) Appl. No.: 16/144,610

(22) Filed: Sep. 27, 2018

Related U.S. Application Data
(60) Provisional application No. 62/587,014, filed on Nov. 16, 2017.

(51) Int. Cl. B01D 53/00; F25J 3/06; F28F 1/00; F28F 17/00

(52) U.S. Cl. CPC B01D 53/002; F25J 3/06; F25J 2205/20; F28F 17/00; F28F 1/006

(57) ABSTRACT

A method, including: flowing a fluid stream including one or more freezable components over a cooled surface, wherein the cooled surface has a cooled surface temperature below a freezing temperature where at least one of the freezable components solidifies out of the fluid stream as a frozen deposit on the cooled surface; separating the frozen deposit from the cooled surface by mechanically deforming at least part of the cooled surface; and heating the frozen deposit separated from the cooled surface to melt, vaporize, or sublimate the frozen deposit.

### CROSS REFERENCE TO RELATED APPLICATIONS

This application claims the priority benefit of U.S. Patent Application No. 62/587,014 filed Nov. 16, 2017 entitled CO₂ CAPTURE VIA DEFORMABLE COLD SURFACES, the entirety of which is incorporated by reference herein.

### BACKGROUND

### Technological Field

The disclosure relates generally to the field of fluid separation. More specifically, the disclosure relates to the cryogenic separation of contaminants, such as carbon dioxide and/or water, from a flue gas.

### Description of Related Art

This section is intended to introduce various aspects of the art, which may be associated with the present disclosure. This discussion is intended to provide a framework to facilitate a better understanding of particular aspects of the present disclosure. Accordingly, it should be understood that this section should be read in this light, and not necessarily as admissions of prior art.

Gas separation is important in various industries, particularly in the production of fuels, chemicals, petrochemicals and specialty products. A gas separation can be accomplished by a variety of methods that, assisted by heat, solids, or other means, generally exploits the differences in physical and/or chemical properties of the components to be separated. For example, gas separation can be achieved by partial liquefaction or by utilizing a solid adsorbent material that preferentially retains or adsorbs a more readily adsorbed component relative to a less readily adsorbed component of the gas mixture, or by several other gas separation techniques known in the industry.

A deformable heat exchanger tube is described in Riordan, Frank, “A deformable heat exchanger separated by a helicoid,” Journal of Physics A: Mathematical and General, v.19.9 (1986), p. 1505, which is hereby incorporated by reference in its entirety. The tube is corrugated to allow bending. Furthermore, a helicoid separator is inside the tube thus allowing two pathways through the tube for two different fluids to transfer heat between them. The reference solely focuses on the design of a specific deformable heat exchanger and does not consider gas separations or deformations while in operation.

An ice formation system is proposed in an article titled “Project—Ice bank system with pulsating and flexible heat exchanger (IPFLEX)”, available from the web site of the Danish Technologies Institute at https://www.dti.dk/projects/project-ice-bank-system-with-pulsating-and-flexible-heat-exchanger-ipflex/37176, which is hereby incorporated by reference in its entirety. This article describes ice forming on flexible hoses that are subjected to a pulsating pressure. This pulsation results in an expansion of the hoses that causes the ice to be released from the surface.

U.S. Pat. No. 5,686,003, which is hereby incorporated by reference in its entirety, describes using a shape memory alloy for deicing, particularly from the wing of an aircraft. The shape memory alloy is periodically flexed to debond ice from the surface.

A study of the strain required to debond ice from a substrate is reported in Laforte, Caroline, and Jean-Louis Laforte, “Tensile, Torsional and Bending Strain at the Adhesive Rupture of an iced Substrate,” ASME 2009 28th Int'l Conf. on Ocean, Offshore and Arctic Engineering, ASME, OMAE2009-79458, 2009, which is hereby incorporated by reference in its entirety. Experimental tests were performed deforming ice-covered materials via tensile, twisting and bending motions. A total of 108 icing/deicing tests were conducted with aluminum and nylon samples covered with hard rime ice deposits 2, 5, and 10 mm thick strained at various strains rates in brittle regime at −10° C.

### SUMMARY

A method, including: flowing a fluid stream including one or more freezable components over a cooled surface, wherein the cooled surface has a cooled surface temperature below a freezing temperature where at least one of the freezable components solidifies out of the fluid stream as a frozen deposit on the cooled surface; separating the frozen deposit from the cooled surface by mechanically deforming at least part of the cooled surface; and heating the frozen deposit separated from the cooled surface to melt, vaporize, or sublimate the frozen deposit.

In the method, the fluid stream can be a flue gas and the one or more freezable components can include CO₂ or water.

In the method, the fluid stream can be primarily composed of methane on a molar basis and the one or more freezable components can include CO₂, water, or benzene.

In the method, the deforming of at least part of the cooled surface can include one or more of bending, elongating, compressing, expanding, or torqueing the cooled surface within an elastic tolerance of the cooled surface.

In the method, the cooled surface can include an outer surface of a tube carrying a flowing coolant.

In the method, the tube can have a shape including a helical structure, a series of loops, or a series of sinusoidal bends.

In the method, the cooled surface can have a moveable end and a fixed end, and the deforming can include moving the moveable end of the cooled surface while holding fixed the fixed end.

The method can further include receiving the separated frozen deposit into a capture area.

The method can further include transporting the separated frozen deposit from the capture area to a heating area where the heating step is executed.

A heat exchanger, including: an inlet port that receives a fluid stream that includes freezable components; a cooled surface over which the fluid stream passes, wherein the cooled surface has a cooled surface temperature below a freezing temperature where at least one of the freezable components solidifies out of the fluid stream as a frozen deposit on the cooled surface, and the cooled surface comprises a coolant-carrying tube with a shape comprising a helical structure, a series of loops, or a series of sinusoidal bends; a deforming device that mechanically deforms the cooled surface causing the frozen deposit to separate from the cooled surface, wherein the deforming device bends, elongates, compresses, expands, or torques the cooled surface within an elastic tolerance of the cooled surface; and an outlet port through which the fluid stream, with a reduction of the freezable components, exits the heat exchanger.

The heat exchanger can include a capture area that receives the frozen deposits separated from the cooling surface.

In the heat exchanger of claim 12, the deforming device can include a motor.

In the heat exchanger, the deforming device can include a pulley system.

The heat exchanger can include a transport device that transports the frozen solid from the capture area.

In the heat exchanger, the transport device can be a screw transporter.

A separation system, comprising: a deformable heat exchanger that includes, an inlet port that receives a fluid stream that includes freezable components, a cooled surface over which the fluid stream passes, wherein the cooled surface has a cooled surface temperature below a freezing temperature where at least one of the freezable components solidifies out of the fluid stream as a frozen deposit on the cooled surface, a deforming device that mechanically deforms the cooled surface and separates the frozen deposit from the cooled surface, and an outlet port through which the fluid stream, with a reduction of the freezable components, exits the deformable heat exchanger, wherein the deforming device bends, elongates, compresses, expands, or torques the cooled surface within an elastic tolerance of the cooled surface; a secondary heat exchanger that cross-heat exchanges coolant exiting the deformable heat exchanger with the fluid stream that has exited the deformable heat exchanger; a refrigeration unit that cools the coolant that has exited the secondary heat exchanger and supplies the coolant to the coolant-carrying tube; and a heating unit that converts the frozen deposits separated from the cooled surface into a fluid or gas.

In the separation system, the heat exchanger can further include a capture area that receives the frozen deposits separated from the cooling surface.

In the separation system, the deforming device can include a motor.

In the separation system, the deforming device can include a pulley system.

The separation system can further include a transport device that transports the frozen solid from the capture area.

In the separation system, the transport device can be a screw transporter.

In the separation system, the deformable heat exchanger can be a corrugated deformable heat exchanger.

In the separation system, the deformable heat exchanger can be a cellular heat exchanger.

In the separation system, the cooled surface can include a coolant-carrying tube with a shape comprising a helical structure, a series of loops, or a series of sinusoidal bends.

### BRIEF DESCRIPTION OF THE DRAWINGS

These and other features, aspects and advantages of the disclosure will become apparent from the following description, appending claims and the accompanying drawings, which are briefly described below.

FIGS. 1A, 1B, 1C, and 1D are non-limiting examples of mechanically deformable cooling tubes.

FIGS. 2A and 2B illustrate non-limiting examples of a heat exchanger embodying the present technological advancement in an undeformed state (FIG. 2A) and a stretched deformed state (FIG. 2B).

FIG. 3 illustrates a non-limiting examples of a deformable heat exchanger embodying the present technological advancement in a separation process with a gaseous process stream.

FIG. 4 illustrates a non-limiting method useable with the present technological advancement.

FIG. 5A illustrates an exemplary corrugated deformable heat exchanger useable with the present technological advancement.

FIG. 5B illustrates an exemplary square cellular heat exchanger (front view) in a deformed state that is useable with the present technological advancement.

FIG. 5C illustrates an exemplary hexagon passageway deformable heat exchanger (front view) useable with the present technological advancement.

It should be noted that the figures are merely examples and no limitations on the scope of the present disclosure are intended thereby. Further, the figures are generally not drawn to scale, but are drafted for purposes of convenience and clarity in illustrating various aspects of the disclosure.

### DETAILED DESCRIPTION

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

As referenced in this application, the terms “stream,” “gas stream,” and “vapor stream,” refer to different stages of a feed stream as the feed stream is subject to a separation process that separates methane, the primary hydrocarbon in natural gas, from contaminants, such as CO₂ and/or water (however, the present technological advancement is not limited to these exemplary contaminants). In some instances, the terms “gas stream” and “vapor stream” may be used interchangeably.

The present technological advancement proposes a heat exchanger design that allows easy removal of frozen solids (e.g., ice or frozen CO₂) from the heat exchanger's cooling surfaces. Such a heat exchanger may be used in the removal of CO₂ and/or water from gaseous streams.

The present technological advancement can include a heat exchanger that has deformable cooled surfaces. The cooled surfaces may be surfaces of coolant-carrying tubes, passages through corrugated or cellular materials. As ice or other frozen solids form on the cooled surfaces (e.g., outer surfaces of tubes carrying cryogenic coolant), the surfaces are periodically physically deformed.

Frozen solids on cooled surfaces of a heat exchanger as part of the present technological advancement may be counter-intuitive to those of ordinary skill in the art as conventional wisdom is to avoid ice or other frozen precipitates from forming in the heat exchanger. The present technological advancement can cause frozen solids to debond from the deformable cooled surfaces of the heat exchanger and fall to an area below the cooled surfaces or be carried away by flow. Most frozen solids tend to be brittle and hence fairly minor deformation can cause debonding. Deformation may involve tension, compression, expansion, torsion, or bending. In the literature it has been reported that strains as little as 0.04% for traction or torsion and 0.004% for bending can cause ice debonding (see article by Laforte and Laforte in the Background section).

An effective design for the present technological advancement has the cooling surfaces preferably remain within its elastic limits so not to be permanently deformed (e.g., elastic deformation, which is not permanent). For cryogenic applications, this may be accomplished using a number of well-known materials that remain ductile at low temperatures—e.g., 3,000 series aluminum alloys, nickel alloys (e.g., Monel K-450 and Hastelloy), ASTM A516 nickel-steels, and titanium alloys (e.g., Ti-5Al-2.5Sn and Ti-6Al-4V alloys). Those of ordinary skill in the art can select suitable materials based on the inherent physical limits of the materials and the particular gases and temperatures involved in a given application.

Depending on the shape of the cooling surfaces and the means of imparting the deformation, the amount of deformation will not necessarily be uniform over the cooling surfaces. Thus, the stress imparted to the cooling surfaces at one or more of the ends may not be the same as the stress or strain imparted to a center region of the cooling surfaces. This may be a design consideration in selecting suitable materials to ensure that the elastic deformation is within the elastic limits and that sufficient stress or strain is imparted across an entirety of the cooling region.

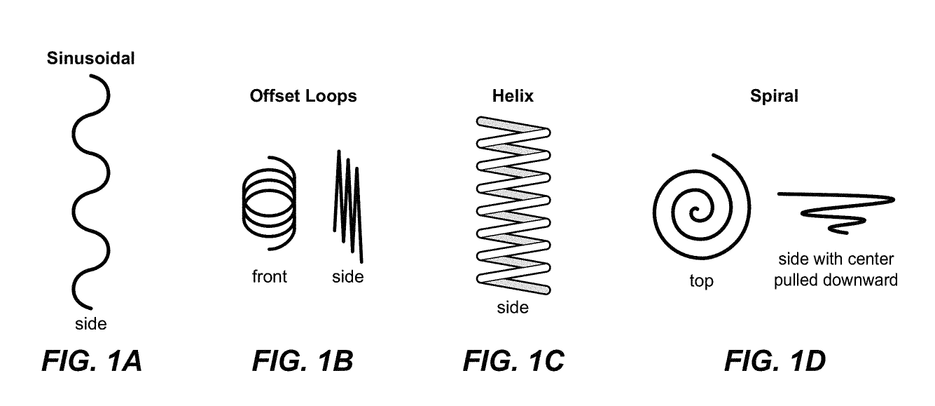

Effective removal of all deposits can be improved with a cooling surface shape where all sections of a cooling surface (e.g., tubes, as a non-limiting example) are more-or-less (e.g., substantially) uniformly deformed since areas that do not sufficiently deform may develop thick ice deposits. In general when a shape is deformed, deformation stresses tends to concentrate at bends. Hence a shape composed of bends of varying degrees (e.g., straight sections and bent sections) will likely exhibit non-uniform deformation when mechanically stressed. To address the requirements of deformation throughout and ensuring elastic deformation, the proposed technological advancement can have the heat exchanger include a series of tubes carrying coolant where the tubes have “spring-like” or serpentine shapes, preferably with substantially uniform curvature throughout. FIGS. 1A, 1B, 1C, and 1D illustrate some exemplary shapes—e.g., planar sinusoidal tubes or surfaces (1A), helical tubes or surfaces (1C), offset looping tubes or surfaces (1B), or spiral tubes or surfaces (1D). Such shapes may be deformed by holding one end fixed while pulling, compressing, and/or twisting the other end. Alternatively, the two ends of the tube may be moved in opposing manners, or in the same manner, but at differing rates of movement or differing amounts of movement in order to achieve a mechanical deformation. Tubes means a hollow elongated member, which may or may not have a circular cross-section.

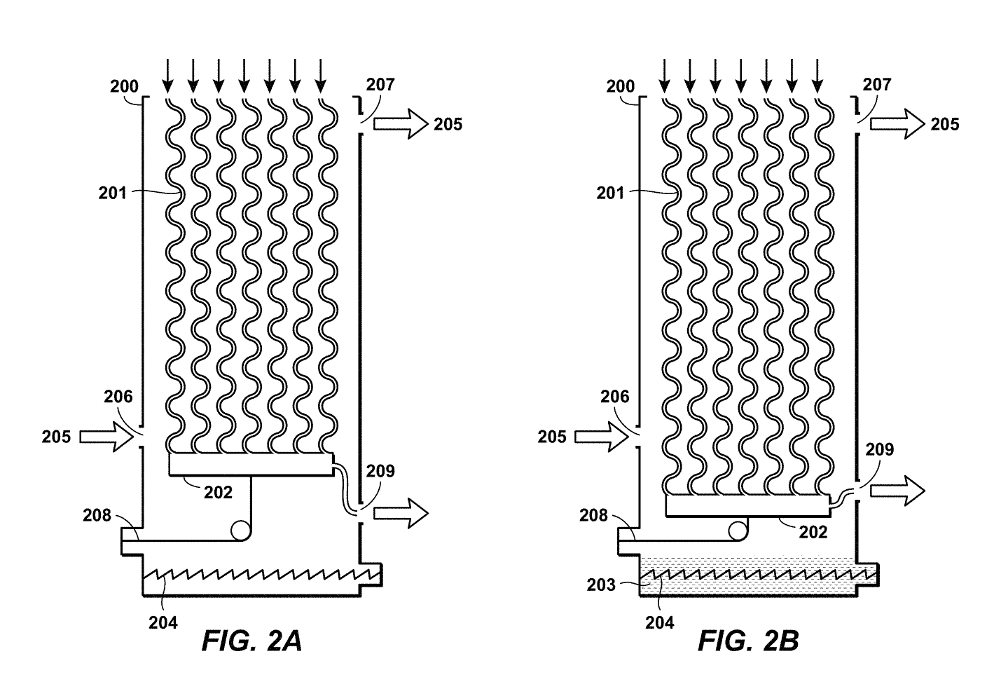

FIGS. 2A and 2B illustrate an embodiment of an exemplary vertical shell-and-tube heat exchanger 200. FIG. 2A illustrates the vertical shell-and-tube heat exchanger 200 with cooling surfaces (tubes 201 in this example) in a first position (e.g., an initial state or non-deformed state) and FIG. 2B illustrates the vertical shell-and-tube heat exchanger 200 with tubes 201 in a second position (e.g., a stretched, twisted, or deformed state, wherein deformed is a distortion in shape relative to the initial state and is not necessarily occurring over an entirety of the length of the tubes 201). Fluid stream 205 (e.g., process gas) enters the heat exchanger 200 at port 206 and exits at port 207. As used herein, the term “fluid” refers to gases, liquids, and combinations of gases and liquids, as well as to combinations of gases and solids, and combinations of liquids and solids. The fluid stream can be primarily composed of methane on a molar basis with one or more freezable components that include CO₂, water, or benzene.

This exemplary embodiment depicts the bottom of a series of coolant tubes 201 being connected via manifold 202, with the coolant existing at 209 in order to complete the coolant loop. The manifold can be moveable by means of a deforming device 208, such as a pulley system and/or motor that in turn causes the tubes to extend, compress, and/or twist. The present technological advancement is not limited to being used with pulley systems or motors. Any deforming device that can supply a force or torque on the tubes 201 could be useable for any given application. For example, the tubes 201 could be made, at least partially from, muscle wire, wherein an electric current supplied to the muscle wire causes the tubes 201 to contract. Furthermore, shape memory alloy material could be used, at least in part, for the tubes 201. Furthermore, the tubes 201 could be connected to a deforming device that subjects the tubes to pulsating pressure, which results in an expansion of the tubes and debonding of the frozen solid 203.

The frozen solid 203 debonded from the tubes 201 falls to the bottom of the heat exchanger shell. The debonded solids may also be at least partially carried away by the flow over the tubes. The frozen solid 203 may be removed from the bottom via a transport device 204. The transport device can include a screw transporter (e.g., an auger, screw feed, ribbon screw, or paddle screw) or a chain conveyer. However, a removable drawer or tray could also be used to collect the ice and remove it from the heat exchanger 200. Use of the screw transporter may be most practical if the shell of the heat exchanger 200 is at near-atmospheric in pressure, which may be the case if the process fluid is flue gas to be cooled to remove CO₂. As used herein, the term “flue gas” means any gas stream generated as a by-product of hydrocarbon combustion. The heat exchanger 200 can be a pressure vessel capable of pressures above or below atmospheric pressure. The transport device 204 can be designed to compact the ice as it is removed. This can prevent a substantial amount of gas from flowing out with the removed ice.

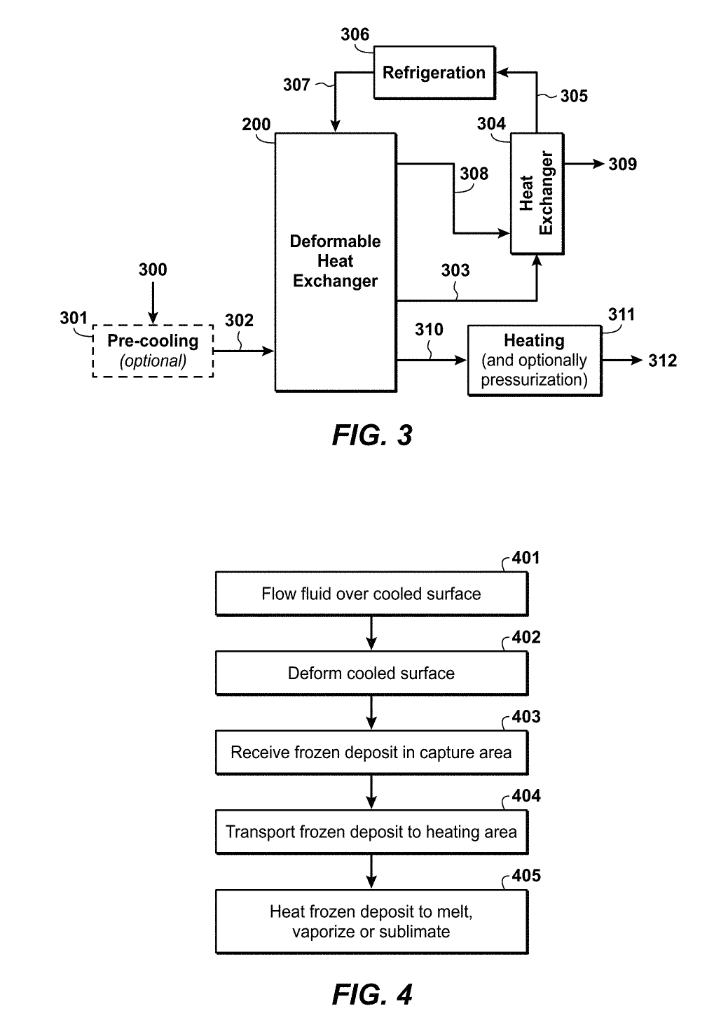

Alternatively, the frozen solid 203 can be permitted to drop or otherwise be moved to a heating area without necessarily being collected at the bottom of heat exchanger 200. For example, there could be a shoot or slide setup to facilitate movement of the solids 203 to another area (e.g., heating area as illustrated in FIG. 3) immediately after they drop from the cooling surfaces 201. To the extent needed, a thermal barrier could be established to thermally separate the cooling tubes 201 from the subsequent heating area.

FIG. 3 illustrates an exemplary schematic of how the proposed heat exchanger 200 can be incorporated into a separation process for removing freezable components from a fluid stream. Not every component shown in FIG. 3 is required, and those of ordinary skill in the art will recognize that certain components can be omitted (e.g., pre-cooling module 301 and heating module 311) or rearranged. FIG. 3 shows that solids 310 can be removed from the deformable heat exchanger 200 and can be transferred to a heating system 311 (with or without pressurization) which vaporizes, melts, or sublimates the solids and forms gaseous or liquid freezable components 312.

The raw process gas or other fluid stream 300 can enter a pre-cooling module 301, and generate pre-cooled fluid stream 302. Pre-cooled fluid stream 302 is then supplied to the heat exchanger 200. The heat exchanger 200 includes cooling surfaces (see FIGS. 2A and 2B), which circulate a cryogenic coolant through loop 303-306, wherein warmed coolant 303 leaving the heat exchanger 200 is cooled via heat exchanger 304 to generate pre-chilled coolant 305, and the pre-chilled coolant 305 is further cooled to a predetermined temperature via refrigeration unit 306 in order to supply heat exchanger 200 with cooled coolant 307. The cooled process gas can be supplied to heat exchanger 308, warmed, and output as processed process gas 309.

FIG. 4 illustrates a non-limiting method useable with the present technological advancement. In this exemplary method, freezable components are separated from a fluid stream that includes freezable components. Step 401 can include flowing the fluid stream over a cooled surface, wherein the cooled surface has a cooled surface temperature below a freezing temperature where at least one of the freezable components solidifies out of the fluid stream as a frozen deposit on the cooled surface. Step 402 can include mechanically deforming the cooled surface to separate the frozen deposit from the cooled surface. Step 403 can include receiving the separated frozen deposit into a capture area. Step 404 can include transferring the separated frozen deposit from the capture area to a heating area. Step 405 can include heating the separated frozen deposit in the heating area to melt, vaporize, or sublimate the frozen deposit.

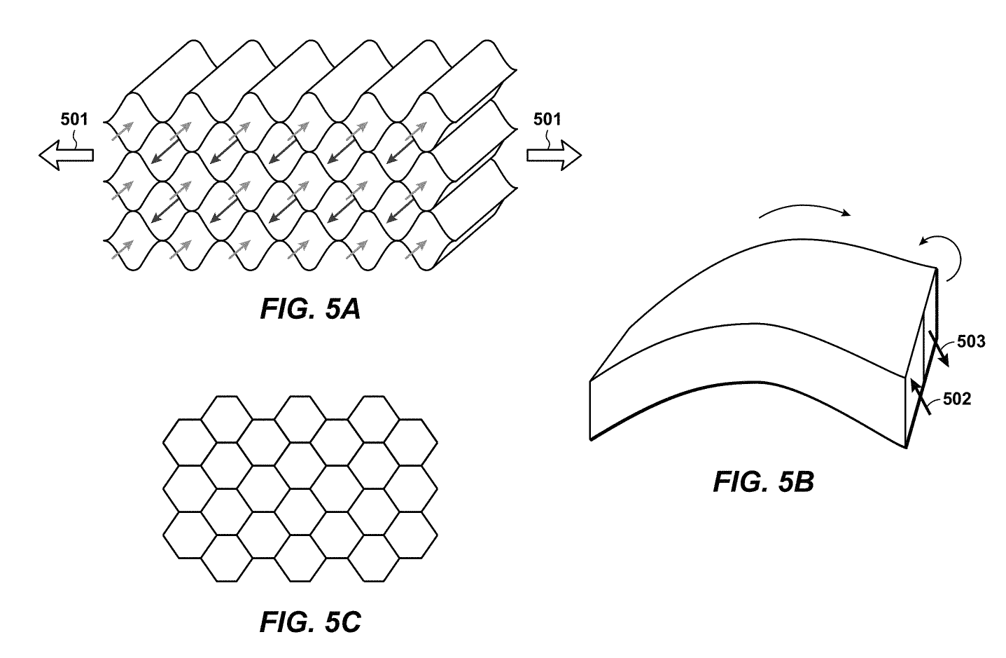

FIG. 5A illustrates an exemplary corrugated deformable heat exchanger useable with the present technological advancement. Arrows 501 indicated that this heat exchanger can be deformed through stretching. Alternatively, the heat exchanger could be deformed through compression. Furthermore, this heat exchanger could be deformed through twisting or bending. The coolant can flow in the regions with the lighter colored arrows and the stream can flow in the regions with the darker colored arrows.

FIG. 5B illustrates an exemplary square cellular heat exchanger (front view) in a deformed state that is useable with the present technological advancement. FIG. 5B illustrates how the heat exchanger can be twisted and/or bent to cause the ice to debond therefrom, wherein arrows 502 and 503 illustrate the flow of the stream and coolant, respectively.

FIG. 5C illustrates an exemplary hexagon passageway deformable heat exchanger (front view) useable with the present technological advancement. This is analogous to the corrugated heat exchanger in FIG. 5A, wherein the cross-sectional shape of the individual cells can be hexagonal. However, any mosaic of cross section shapes can be used.

Moreover, while different heat exchangers are discussed herein, a system embodying the present technological advancement can include multiple heat exchangers of the same or different type.

Disclosed aspects of the present technological advancement may be used in hydrocarbon management activities. As used herein, “hydrocarbon management” or “managing hydrocarbons” includes hydrocarbon extraction, hydrocarbon production, hydrocarbon exploration, identifying potential hydrocarbon resources, identifying well locations, determining well injection and/or extraction rates, identifying reservoir connectivity, acquiring, disposing of and/or abandoning hydrocarbon resources, reviewing prior hydrocarbon management decisions, and any other hydrocarbon-related acts or activities. The term “hydrocarbon management” is also used for the injection or storage of hydrocarbons or CO₂, for example the sequestration of CO₂, such as reservoir evaluation, development planning, and reservoir management. The disclosed methodologies and techniques may be used in extracting hydrocarbons from a subsurface region and processing the hydrocarbons.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numeral ranges provided. Accordingly, these terms should be interpreted as indicating that insubstantial or inconsequential modifications or alterations of the subject matter described and are considered to be within the scope of the disclosure. Furthermore, the articles “the,” “a” and “an” are not necessarily limited to mean only one, but rather are inclusive and open ended so as to include, optionally, multiple such elements.

It should be understood that the numerous changes, modifications, and alternatives to the preceding disclosure can be made without departing from the scope of the disclosure. The preceding description, therefore, is not meant to limit the scope of the disclosure. Rather, the scope of the disclosure is to be determined only by the appended claims and their equivalents. It is also contemplated that structures and features in the present examples can be altered, rearranged, substituted, deleted, duplicated, combined, or added to each other.

What is claimed is:

1. A method, comprising:
flowing a fluid stream including one or more freezable components over a cooled surface, wherein the cooled surface has a cooled surface temperature below a freezing temperature where at least one of the freezable components solidifies out of the fluid stream as a frozen deposit on the cooled surface;
separating the frozen deposit from the cooled surface by mechanically deforming at least part of the cooled surface; and
heating the frozen deposit separated from the cooled surface to melt, vaporize, or sublimate the frozen deposit.

2. The method of claim 1, wherein the fluid stream is a flue gas and the one or more freezable components includes CO₂ or water.

3. The method of claim 1, wherein the fluid stream is primarily composed of methane on a molar basis and the one or more freezable components includes CO₂, water, or benzene.

4. The method of claim 1, wherein the deforming of at least part of the cooled surface comprises one or more of bending, elongating, compressing, expanding, or torqueing the cooled surface within an elastic tolerance of the cooled surface.

5. The method of claim 1, wherein the cooled surface comprises an outer surface of a tube carrying a flowing coolant.

6. The method of claim 5, wherein the tube has a shape comprising a helical structure, a series of loops, or a series of sinusoidal bends.

7. The method of claim 1, wherein the cooled surface has a moveable end and a fixed end, and the deforming comprises moving the moveable end of the cooled surface while holding fixed the fixed end.

8. The method of claim 1, further comprising receiving the separated frozen deposit into a capture area.

9. The method of claim 8, further comprising transporting the separated frozen deposit from the capture area to a heating area where the heating step is executed.

10. A heat exchanger, comprising:
an inlet port that receives a fluid stream that includes freezable components;
a cooled surface over which the fluid stream passes,
wherein the cooled surface has a cooled surface temperature below a freezing temperature where at least one of the freezable components solidifies out of the fluid stream as a frozen deposit on the cooled surface, and
the cooled surface comprises a coolant-carrying tube with a shape comprising a helical structure, a series of loops, or a series of sinusoidal bends;
a deforming device that mechanically deforms the cooled surface causing the frozen deposit to separate from the cooled surface,
wherein the deforming device bends, elongates, compresses, expands, or torques the cooled surface within an elastic tolerance of the cooled surface; and
an outlet port through which the fluid stream, with a reduction of the freezable components, exits the heat exchanger.

11. The heat exchanger of claim 10, further comprising a capture area that receives the frozen deposits separated from the cooling surface.

12. The heat exchanger of claim 10, wherein the deforming device includes a motor.

13. The heat exchanger of claim 10, wherein the deforming device includes a pulley system.

14. The heat exchanger of claim 11, further comprising a transport device that transports the frozen solid from the capture area.

15. The heat exchanger of claim 12, wherein the transport device is a screw transporter.

16. A separation system, comprising:
a deformable heat exchanger that includes,
an inlet port that receives a fluid stream that includes freezable components,
a cooled surface over which the fluid stream passes,
wherein the cooled surface has a cooled surface temperature below a freezing temperature where at least one of the freezable components solidifies out of the fluid stream as a frozen deposit on the cooled surface, and
a deforming device that mechanically deforms the cooled surface and separates the frozen deposit from the cooled surface, and
an outlet port through which the fluid stream, with a reduction of the freezable components, exits the deformable heat exchanger,
wherein the deforming device bends, elongates, compresses, expands, or torques the cooled surface within an elastic tolerance of the cooled surface;
a secondary heat exchanger that cross-heat exchanges coolant exiting the deformable heat exchanger with the fluid stream that has exited the deformable heat exchanger;
a refrigeration unit that cools the coolant that has exited the secondary heat exchanger and supplies the coolant to the coolant-carrying tube; and
a heating unit that converts the frozen deposits separated from the cooled surface into a fluid or gas.

17. The system of claim 16, wherein the heat exchanger further comprises a capture area that receives the frozen deposits separated from the cooling surface.

18. The system of claim 16, wherein the deforming device includes a motor.

19. The system of claim 16, wherein the deforming device includes a pulley system.

20. The system of claim 17, further comprising a transport device that transports the frozen solid from the capture area.

21. The system of claim 20, wherein the transport device is a screw transporter.

22. The system of claim 16, wherein the deformable heat exchanger includes a corrugated deformable heat exchanger.

23. The system of claim 16, wherein the deformable heat exchanger includes a cellular heat exchanger.

24. The system of claim 16, wherein the cooled surface comprises a coolant-carrying tube with a shape comprising a helical structure, a series of loops, or a series of sinusoidal bends.
